(19) United States
(12) Patent Application Publication
(10) Pub. No.: US 2017/0270519 A1
(43) Pub. Date: Sep. 21, 2017

(54) ENABLING A SECURE CARD ON FILE OPTION FOR ELECTRONIC MERCHANT APPLICATIONS

(71) Applicants: Thomas Purves, San Francisco, CA (US); Jaesung Park, San Francisco, CA (US)

(72) Inventors: Thomas Purves, San Francisco, CA (US); Jaesung Park, San Francisco, CA (US)

(21) Appl. No.: 15/462,586

(22) Filed: Mar. 17, 2017

Related U.S. Application Data
(60) Provisional application No. 62/309,836, filed on Mar. 17, 2016.

(51) Int. Cl. G06Q 20/38; G06Q 20/32; G06Q 20/40

(52) U.S. Cl. CPC G06Q 20/385; G06Q 20/40; G06Q 20/322

(57) ABSTRACT

The present system may allow a user to transfer data about a transaction card that has been entered in a payment application to be “on file” with a merchant. As a result, the consumer does not have to enter electronic payment information again as the data is transferred from the payment application to the merchant application where the card is then held on file.

### BACKGROUND

Consumers are becoming more and more comfortable shopping online for merchandise. Purchasing online merchandise usually requires a form of electronic payment and consumers are always careful in sharing electronic payment information. Trying to convince users to add a transaction card to be “on file” or pre-entered is a difficulty from a security standpoint even though consumers and merchants find the transactions easier to complete using a transaction card that is pre-entered or on file.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

The present system allows a user to transfer data about a transaction card that has been entered in a payment application that is separate from the merchant to be available as “on file” with a merchant. As a result, the consumer does not have to enter electronic payment information again for future transactions as the data is transferred from the payment application to the merchant application where the card is then held on file.

In execution, the present system may start in the merchant payment application where the application may receive a selection to add a payment account using the payment application. In response to receiving selection of an option to add the account to a merchant as a card on file using a payment service, the payment service may be called up and the payment service login and payment service password may be entered. In response to authorization of the payment service login password, at least one payment account linked to the payment service may be displayed. A selection of a chosen payment account may be received and the payment account may be added to the merchant payment application as a card on file.

In some embodiments, a system may securely add a payment account to an electronic merchant payment application using a token-based electronic payment service. The system may comprise an electronic merchant payment application stored in a memory of a mobile computing device and a payment processing system server. The mobile computing device may include a processor that, upon executing instructions of the electronic merchant payment application sends a selection to add a payment account. The payment processing system server may include a processor and a memory storing a payment service module. The payment service module may include instructions that, when executed by the processor, cause the payment processing system server to receive the selection to add the payment account to the electronic merchant payment application. In response to receiving the selection, the instructions may further cause the payment processing system server to authorize the selection to add the payment account to the electronic merchant payment application. In response to authorizing the selection to add the payment account to the electronic merchant payment application, the instructions may link primary account holder data to the electronic merchant payment application.

In further embodiments, a method may securely add a payment account to an electronic merchant payment application using a token-based electronic payment service. The method may send a selection to add a payment account to an electronic merchant payment application executing on a mobile computing device, and receive the selection to add the payment account to the electronic merchant payment application at a payment processing system server remote from the mobile computing device. The method may also, in response to receiving the selection to add the payment account to the electronic merchant payment application, authorize the selection to add the payment account to the electronic merchant payment application. The method may also, in response to authorizing the selection to add the payment account to the electronic merchant payment application, link primary account holder data to the electronic merchant payment application.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an exemplary system for adding a payment account to an electronic merchant payment application using a token-based electronic payment application;

FIG. 2A and FIG. 2B are different views of an exemplary payment device;

FIG. 3 is an illustration of an interface for an exemplary merchant application;

FIG. 4 is an illustration of an interface for an exemplary electronic merchant payment application with an add payment method option being displayed in the interface;

FIG. 5 is an illustration of an interface for an exemplary electronic merchant payment application with an add card using a payment application option being displayed in the interface

FIG. 6 is an illustration of an interface for an exemplary electronic merchant payment application with a sign in user interface for an existing payment application user displayed in the interface;

FIG. 7 is an illustration of an interface for an exemplary electronic merchant payment application with two available payment devices being displayed in the interface to be added to the electronic merchant payment application;

FIG. 8 is an illustration of an interface for an exemplary electronic merchant payment application showing a payment device from the application being available to be used in the electronic merchant payment application;

FIG. 9 is an illustration of an interface for an exemplary electronic merchant payment application showing a payment device from the application being used to make a purchase in the application;

FIG. 10 is an illustration of an exemplary flow of a payment device being added from a payment application to a merchant application and used as payment with an electronic merchant payment application;

FIG. 11 illustrates an exemplary process flow for creating and using a token within the systems and methods described herein;

FIG. 12 is an illustration of an interface for an exemplary electronic merchant payment application showing an alternate login option; and

FIG. 13 is an illustration of an exemplary computing device that may be physically configured to execute the methods described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

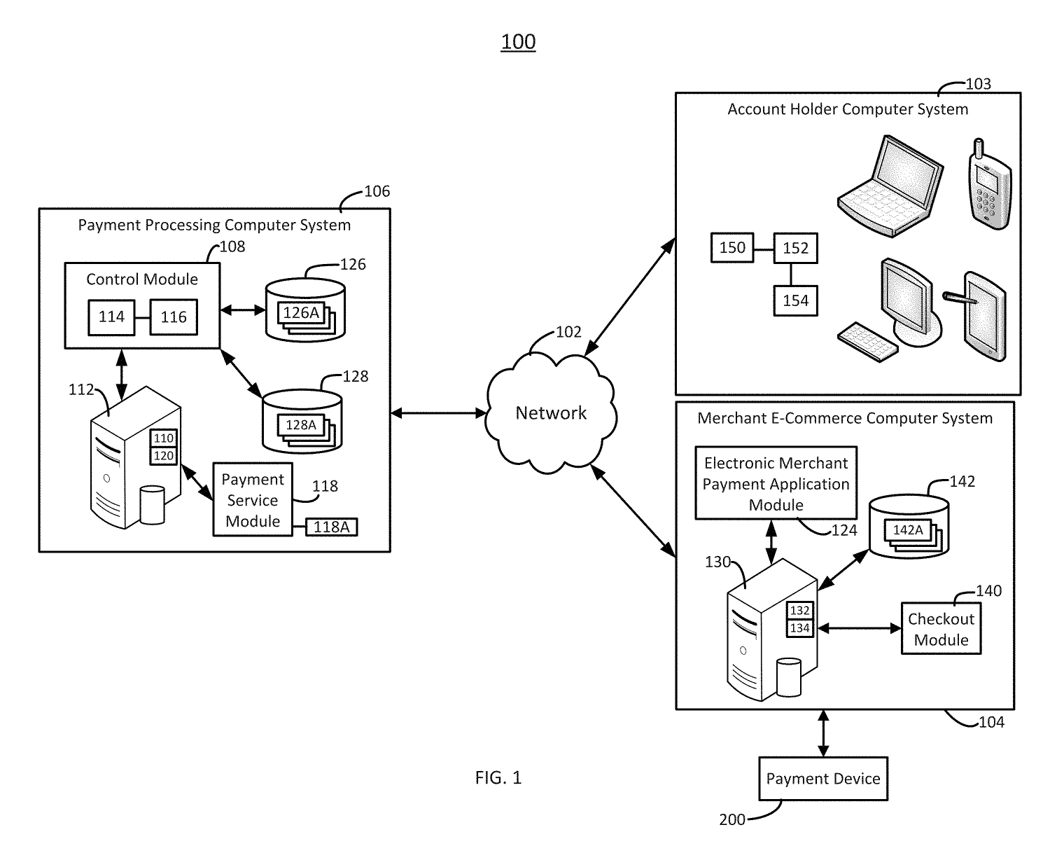

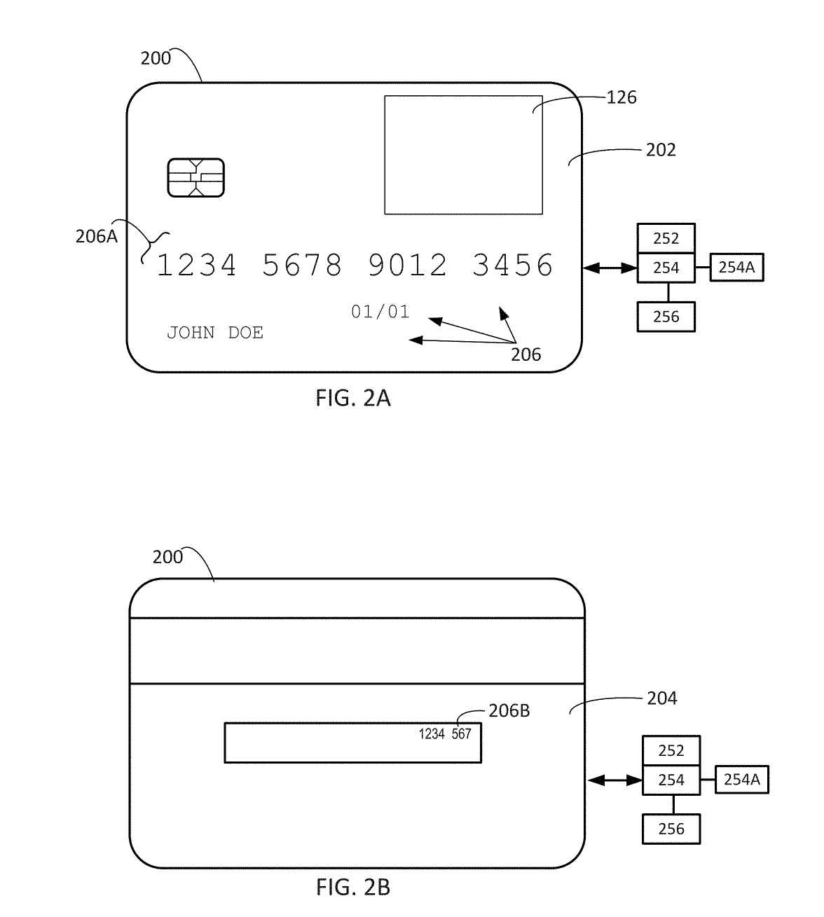

FIG. 1 generally illustrates one embodiment of a system 100 for adding a payment account to an electronic merchant payment application using a token-based electronic payment application. The system 100 may include a computer network 102 that links one or more systems and computer components. In some embodiments, the system 100 includes an account holder computer system 103, a merchant e-commerce computer system 104, a payment processing computer system 106 and a payment device 200 (FIGS. 2A and 2B). The network 102 may be described variously as a communication link, computer network, internet connection, etc. The system 100 may include various software or computer-executable instructions stored on tangible memories and specialized hardware components or modules that employ the software and instructions to add a payment account to an electronic merchant payment application using a token-based electronic payment application, as described herein. The various modules may be implemented as computer-readable storage memories containing computer-readable instructions (i.e., software) for execution by one or more processors of the system 100 within a specialized or unique computing device. The modules may perform the various tasks, methods, modules, etc., as described herein. The system 100 may also include both hardware and software applications, as well as various data communications channels for communicating data between the various specialized and unique hardware and software components.

The payment processing computer system 106 may include one or more instruction modules including a control module 108 that, generally, may include instructions to cause a processor 110 of a payment processing system server 112 to functionally communicate with a plurality of other computer-executable steps or modules, e.g., modules 114, 116, 118, and components of the system 100 via the network 102. These modules 114, 116, 118 may include instructions that, upon loading into the server memory 120 and execution by one or more computer processors 110, link a payment device 200 or data representing the payment device 200 (i.e., a payment payload 128A) to an electronic merchant payment application 154 configured to execute on an account holder computer system 103 to add the payment device to the electronic merchant payment application 154 using a token-based electronic payment application. A first data repository 126 may include primary account holder data 126A that each includes various pieces of data to describe an account of a primary account holder and user of the payment processing computer system 106. In some embodiments, primary account holder data 126A or a portion of the primary account holder data 126A may be included with a payment device 200 as the payment payload 128A, as described herein.

A second data repository 128 may include a plurality of payment payload data 128A that include payment information from primary account holder data 126A that may be linked by a linking module 114 to the electronic merchant payment application and or sent to the merchant e-commerce computer system 104. A tokenizing module 116 may include instructions to tokenize primary account holder data 126A into a payment payload 128A to be linked by the linking module 114 to the electronic merchant payment application 154 and sent to the merchant e-commerce computer system 104 so that a user may easily use the electronic merchant payment application 154 to complete purchases without having to constantly re-enter payment account data for every purchase with the application 154. A payment service module 118 may include instructions to facilitate the linking module 114 and the tokenizing module 116 within the electronic merchant payment application 154 as well as providing a gateway for other applications or services to include data representing a payment device 200 as “on file” for use with those applications or services.

The merchant e-commerce computer system 104 may include any components that are used by a business to complete an internet-based, e-commerce transaction where a customer uses a payment device 200 to link a payment payload 128A or other payment data to the electronic merchant payment application 154. For example, the system 104 may include an e-commerce server 130 having an e-commerce processor 132 and e-commerce memory 134. The memory 134 may include processor implemented instructions such as the electronic merchant payment application module 124 and a checkout module 140 that is used by the system 104 to gather a payment payload data 128A, including an amount for a transaction between the account holder computer system 103 and the merchant-commerce computer system 104, customer account information (e.g., a Personal Account Number (“PAN”) 206A and a Card Verification number (“CVN”) 206B), and customer account data 142A from an account data repository 142.

With brief reference to FIGS. 2A and 2B, an exemplary payment device 200 (FIGS. 2A and 2B) may take on a variety of shapes and forms. In some embodiments, the payment device 200 is a traditional card such as a debit card or credit card. In other embodiments, the payment device 200 may be a fob on a key chain, an NFC wearable, or other device. As long as the payment device 200 is able to communicate securely with the payment processing computer system 106 and the merchant e-commerce computer system 104, the form of the payment device 200 may not be especially critical and may be a design choice for the embodiments described herein. For example, many legacy payment devices may have to be read by a magnetic stripe reader and thus, the payment device 200 may have to be sized to fit through a magnetic card reader. In other examples, the payment device 200 may communicate through near field communication and the form of the payment device 200 may be virtually any form. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 including the PAN 206A and the CVN 206B. In some embodiments, the payment device 200 may include data corresponding to the primary account holder, such as a primary account holder data 126A for the primary account holder. A memory 254 generally and a module 254A in particular may be encrypted such that all data related to payment is secure from unwanted third parties. A communication interface 256 may include instructions to facilitate sending payment information or a token to identify payment information to the merchant e-commerce computer system 104, which then passes the payment data/token to the payment processing computer system 106 via the network 102.

Returning to FIG. 1, a checkout module 140 of the payment processing system server 112 may include various instructions that, upon execution by the processor 132, facilitate, in general, employing a payment device 200 for a merchandise transaction with the merchant e-commerce computer system 104 and, in particular, linking the device 200 or data related to the device (e.g., primary account holder data 126A) to the merchant payment application 154. The checkout module 140 may include instructions that, upon loading into the memory 134 of the server 130 and execution by one or more computer processors 132, allow a user to employ the payment device 200 and his or her corresponding customer account data 142A and primary account holder data 126A to complete a payment using, for example, the PAN 206A and other data from the payment device that is communicated to the merchant e-commerce computer system 104 via a payment payload 128A (tokenized or untokenized) and also coordinate with the control module 108 to permit interaction with the linking module 114, as described herein. In some embodiments, the checkout module 140 may include instructions to process a payment payload 128A or other transaction data (e.g., a transaction amount, customer value-added service data, etc.) during an in-person or online financial transaction between a primary account holder using the merchant payment application 154 and a merchant using data representing the payment device 200, the account holder computer system 103 executing the merchant payment application 154, and the merchant e-commerce computer system 104, respectively. For example, the module 140 may include instructions to access one or more of customer account data 142A, primary account holder data 126A, a payment payload 128A, or other data used in the transaction to consummate a purchase transaction with the merchant payment application 154, as described herein.

The account holder computer system 103 may be a personal computer, mobile computing device (e.g., mobile phone, tablet, etc.) or other computing device that is capable of accessing the merchant e-commerce computer system 104 and the payment processing computer system 106 via the network 102. The account holder computer system 103 may include a processor 150 and memory 152. The memory 152 may include one or more modules (e.g., the merchant application 154) including instructions that, when executed by the processor 150 cause the account holder computer system 103 to access the merchant e-commerce computer system 104 and the payment processing computer system 106. In some embodiments, the account holder computer system 103 may include one or more modules such as the merchant payment application 154 that facilitate linking a payment payload 128A or other data representing the payment device 200 to the merchant payment application 154 without having to re-enter payment details for every transaction with the merchant payment application 154, as described herein.

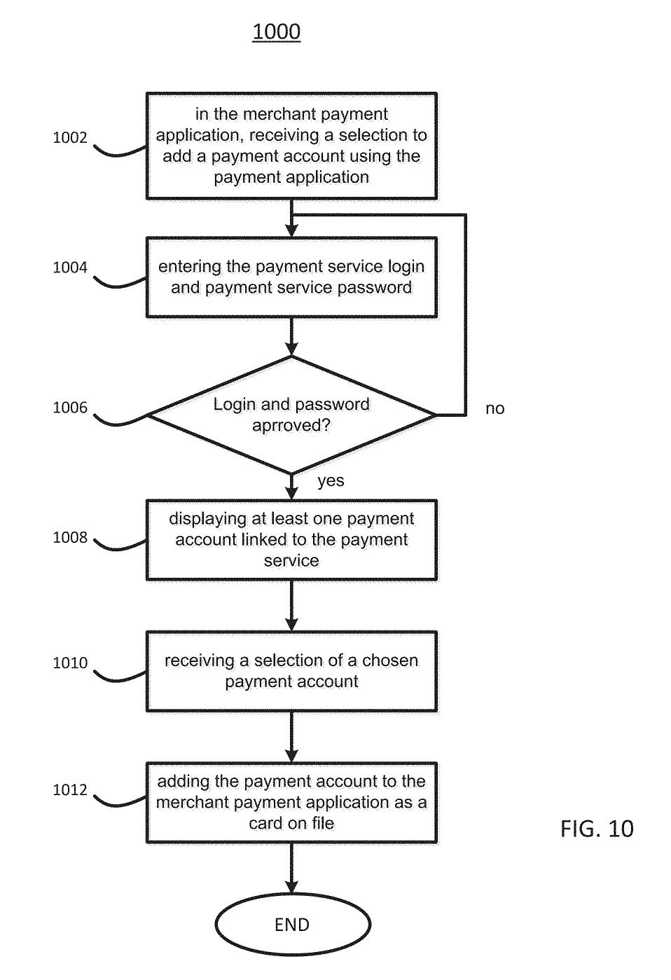

Referring to FIG. 10, a method 1000 of adding a payment account to an electronic merchant payment application 154 using a token-based electronic payment application (e.g., the linking module 114 and the tokenizing module 116) is disclosed. Purchasing online merchandise usually requires a form of electronic payment and consumers are always careful in sharing electronic payment information. Trying to convince users to add a transaction card to be “on file” or pre-entered is difficult as consumers are cautious about any loss of control, real or implied, over sensitive information is objectionable to most consumers. Despite this drawback, both consumers and merchants find the transactions easier to complete using a transaction card that is pre-entered or on file.

An electronic merchant payment application 154 may be a secure web site or application including instructions for execution on a processor of a computing device (e.g., the account holder computing device 103) that a user sets up in advance to enable use of one or more payment accounts for payment devices 200 in the electronic merchant payment application 154. For example, a user may add data representing a payment device 200 to a payment account and the consumer may use the application 154 to select either the debit or credit account to complete a transaction. The user may only have to provide a login and a password to access the payment application 154 and the debit and credit accounts stored therein rather than having to enter the entire debit card number, the debit card expiration, the debit card CCV, the debit card zip code, etc. or the credit card number (PAN), the credit card expiration, the credit card CCV, the credit card zip code, etc. An example of a payment application may be Visa Checkout.

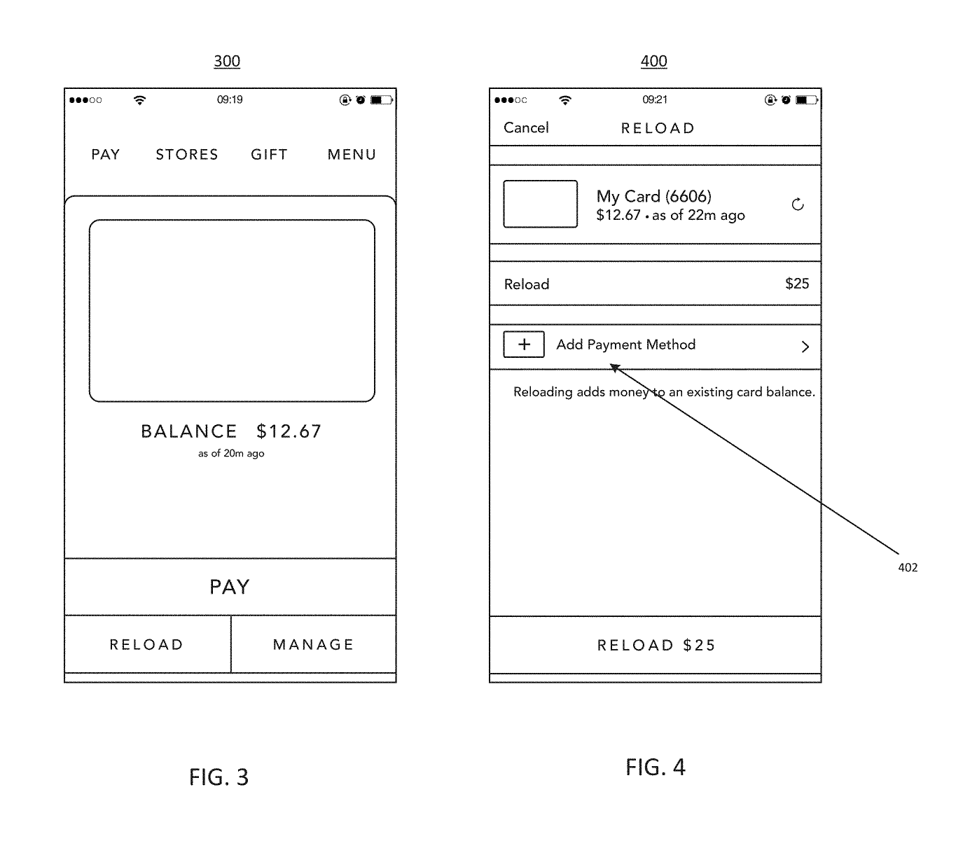

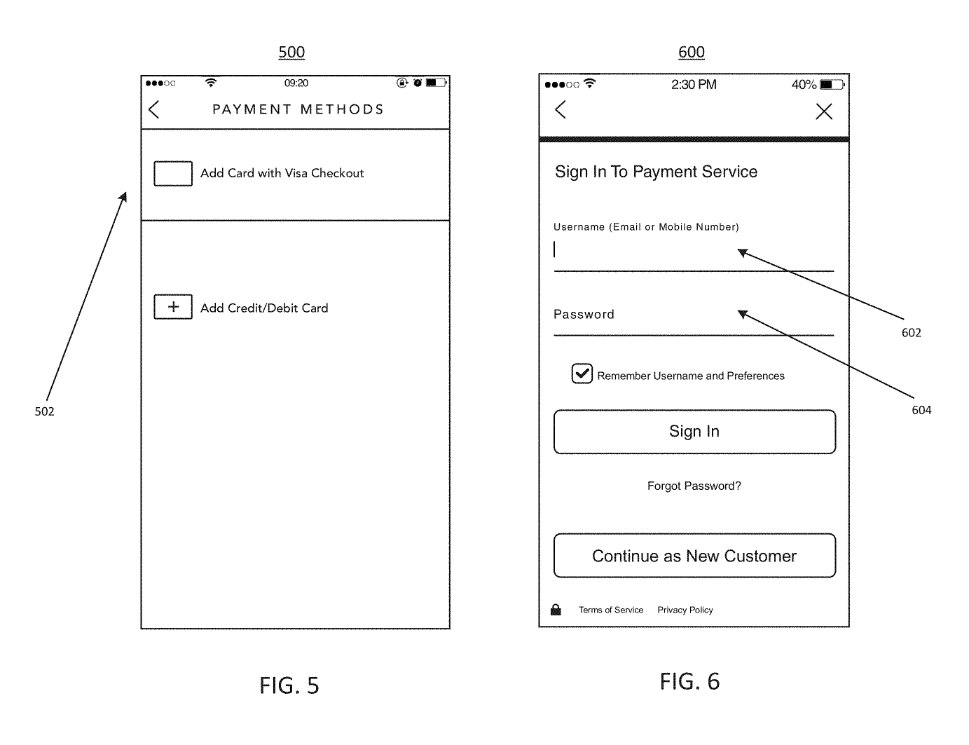

The electronic merchant payment application module 124 may be a web site or network accessible location at the merchant e-commerce computer system 104 where a consumer may purchase goods or services or even replenish an account. The merchant e-commerce computer system 104 may operate the electronic merchant payment application module 124 or may outsource the electronic merchant payment application module 124 to another while lending branding and inventory support to the outsource partner. Examples of merchant web sites are many and varied from Levi's.com to Gap.com. FIGS. 3-9 and 12 may illustrate exemplary interfaces for adding a payment account using an existing payment account to the electronic merchant payment application 154 and making secure payments with the application 154.

Referring to FIG. 10, a method 1000 for linking data representing a payment device 200 to an electronic merchant payment application 154 using a token-based electronic payment application is disclosed. Each step of the method may be performed on a server or other computing device including instructions that, when executed by a processor, perform the action or block described herein.

At block 1002, in an interface 300 (FIG. 3) of a merchant payment application 154 (FIG. 1), a selection may be made to add a payment account 402 (FIG. 4) within the interface 400 using the electronic merchant payment application 154. The selection may be made in a variety of ways within the interface 400 such as selecting a graphic object within the interface 400, using a drop down menu to select an option, issuing a command using a command line type interface, etc. The selection may be an option added to the electronic merchant payment application 154 using directions or control commands from a central authority.

At block 1004, in response to receiving the selection to add the account to the electronic merchant payment application as a card on file 502 in the interface 500, a user with an existing payment application account 142A (FIG. 1) may enter a login 602 and password 604 in the interface 600 for the payment service module 118.

At block 1006, the method 1000 may determine if the login 602 and password 604 entered at block 1004 are authorized. The login 602 and password 604 may be passed to a payment service module 118 of the payment processing computer system 106 (FIG. 1) which may securely store the login 602 and password 604 for future transactions using the payment service module 118. In some embodiments, the payment service module 118 includes an encryption module 118A for securing the login 602 and password 604 as they are communicated from the account holder computer system 103 to other elements of the system 100. In further embodiments, a payment payload 126A may also be encrypted by the encryption module 118A. In these embodiments, the payment payload 126A may be encrypted and/or tokenized by the tokenizing module 116 before sending the payment payload 126A to the merchant e-commerce computer system 104 to complete a transaction between the account holder computer system 103 and the merchant e-commerce computer system 104 using a linked, “card on file” of the electronic merchant payment application 154.

If the payment service module 118 approves the login 602 and password 604, the payment processing computer system 106 may communicate an approval message to one or more of the account holder computer system 103 and the merchant e-commerce computer system 104. Conversely, if the payment service module 118 does not approve the login 602 and password 604, the payment processing computer system 106 may communicate a denial message to one or more of the account holder computer system 103 and the merchant e-commerce computer system 104.

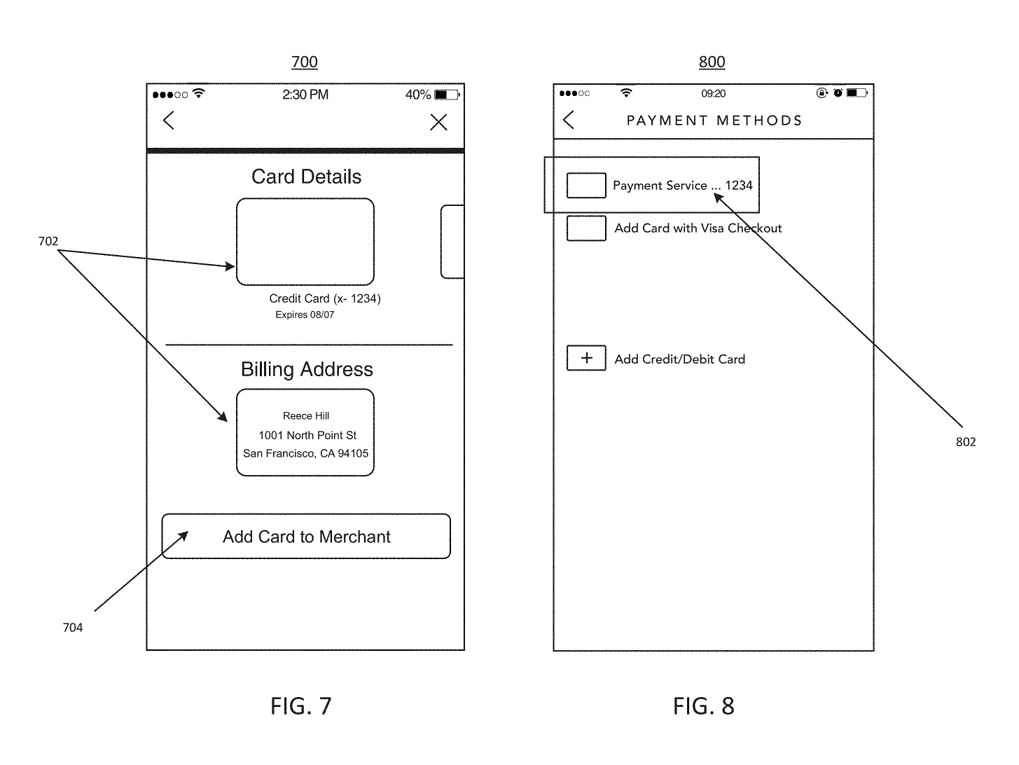

At block 1008, in response to receiving an approval message at the account holder computer system 103, the linking module 114 may execute instructions to link primary account holder data 126A corresponding to the login 602 and password 604 to the payment service module 118. This linking to the payment service module 118 may also cause an interface 700 (FIG. 7) of the electronic merchant payment application 154 to display an indication 702 that at least one payment device 200 corresponding to primary account holder data 126A, login 602, and password 604 is linked to the payment service module 118 and available for a transaction using the electronic merchant payment application. The payment service module 118 may also include numerous payment accounts such as credit cards, debit cards, checking accounts or even points based accounts.

At block 1010, the system 100 may receive a selection of the linked payment device 200 from the interface 700 (FIG. 7) of the electronic merchant payment application 154. In some embodiments, a user may select the indication 702 of the payment device 200 corresponding to the primary account holder data 126A, login 602, and password 604, as displayed within the interface 700. In further embodiments, a user may select the indication 802 (FIG. 8) of the payment device 200 corresponding to the primary account holder data 126A, login 602, and password 604, as displayed within the interface 800. The selection may be received by the payment service module 118 which may then cause the tokenizing module 116 to execute instructions to tokenize the primary account holder data 126A into a payment payload 128A. The payment service module 118 may then forward the payment payload data 128A to the merchant e-commerce computer system 104 to complete payment for the transaction initiated by the account holder computer system 103.

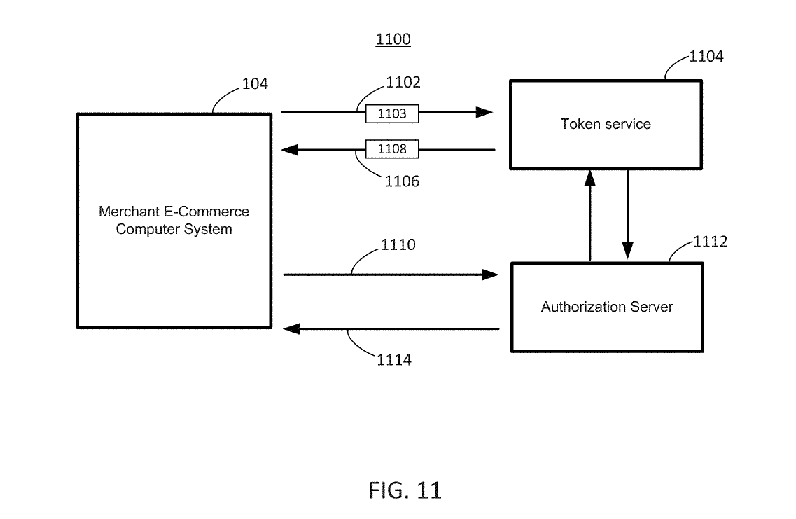

With reference to FIG. 11, in some embodiments, a method 1100 may convert the primary account holder data into a token at block 1010 (FIG. 10) that represents a PAN and/or other primary account holder data 126A for use in linking the payment device 200 to the electronic merchant payment application 154 as herein described. FIG. 11 may illustrate at a high level how tokens may operate to store the primary account holder data 126A as a “card on file” for use in transactions between the electronic merchant payment application 154 and the merchant e-commerce computer system 104. In a first step 1102, the electronic merchant payment application module 124 or other module of the merchant e-commerce computer system 104 may execute instructions to issue a request 1103 to a token service 1104 to receive payment data for a consumer. In a next step, a token service 1104 (e.g., the tokenizing module 116) of the payment processing computer system 106 may generate a response 1106 that includes a token 1108. The token 1108 may take the place of a personal account number (PAN) or other primary account holder data 126A of the user. The token 1108 may be able to be converted by the token service 1104 into the PAN, but no other entity could perform the same conversion. The merchant e-commerce computer system 104 may request via communication 1110 authorization on behalf of the customer to an authorization server 1112 (i.e., a module of the payment processing system server 112) using the received token 1108 as the payload. The authorization server 1112 may request confirmation of the token 1108 via communication with the token service 1104 and provide an authorization response 1114. The token 1108 alone may be useless, but the token service 1104 may translate the token 1108 into a PAN while the PAN may not be exposed over a network.

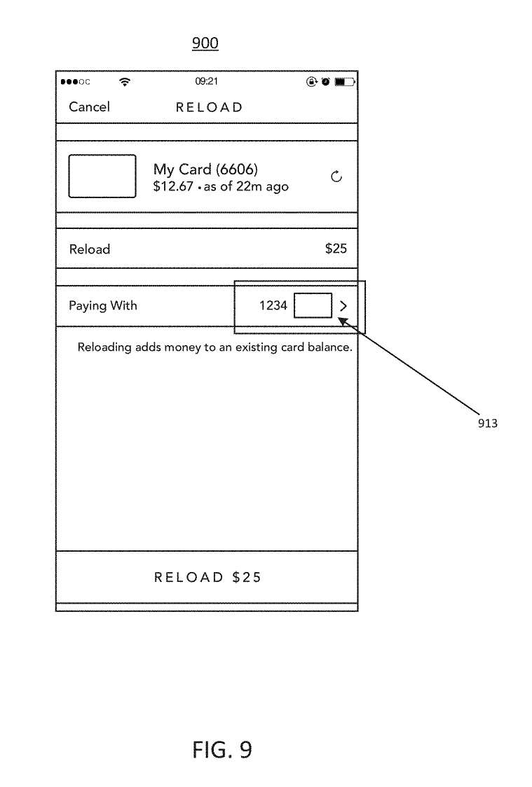

Returning to FIG. 10, at block 1012, data representing the payment device 200 may be added to the electronic merchant payment application 154 as a card on file. With reference to FIG. 9, an interface 900 of the electronic merchant payment application 154 may include an indication 902 that the device 200 is linked. In one embodiment, adding the payment device 200 to the electronic merchant payment application 154 as a card on file may also entail communicating the payment payload 128A to the merchant e-commerce computer system 104. In another embodiment, adding the payment device 200 to the electronic merchant payment application 154 as a card on file includes communicating a link to primary account holder data 126A stored with the customer account data 142A at the merchant e-commerce computer system 104. In yet another embodiment, the payment payload data 128A may be tokenized by the tokenizing module 116 and stored at the merchant e-commerce computer system 104.

In some embodiments, merchant application credentials may be used to login into the payment service module 118 such as Visa Checkout. More specifically, the merchant application credentials may be used to sign in to a payment service 118 as a returning user or to sign up for a payment service. In this embodiment, a user would not need multiple credentials. In addition, the log in process for returning users may be faster as the user will not have to type in data.

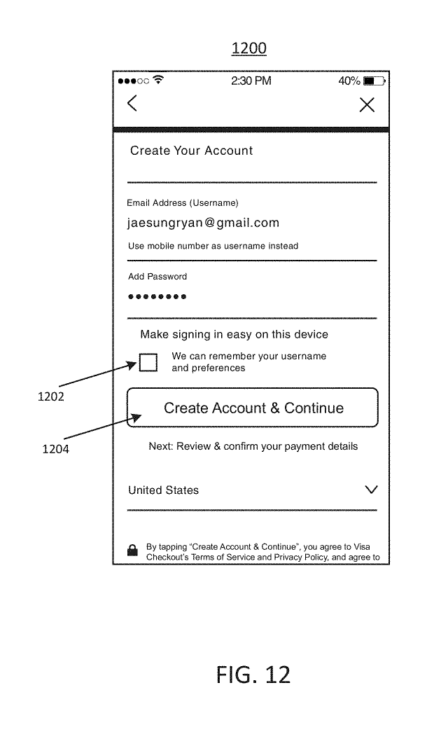

As an example, in FIG. 12, an interface 1200 of the electronic merchant payment application 154 allow the user to login to the payment service module 118 using the same login 602 and password 604 described in relation to FIG. 6 as an option 1202. If user selects the option, log in verification takes place the next time the user returns to the app. Further, when the returning user selects a “Create Account and Continue” option 1204, the graphical user interface of FIG. 6 may be bypassed and the electronic merchant payment application 154 may execute instructions to display the interface 700 of FIG. 7, as described above. To enable option 1202 and 1204, the electronic merchant payment application 154 may execute instructions to pass payment credentials (e.g., login 602 and password 604) to the payment service module 118. A flag may be added to the communications from the electronic merchant payment application 154 if the options 1202, 1204 have been selected. If the flag is set, the payment service module 118 may use the credentials and initiate a log in into the payment service module 118. If the options 1202 and 1204 are not enabled, the electronic merchant payment application 154 may execute instructions to display FIG. 6 as usual and the regular log in flow described herein may continue.

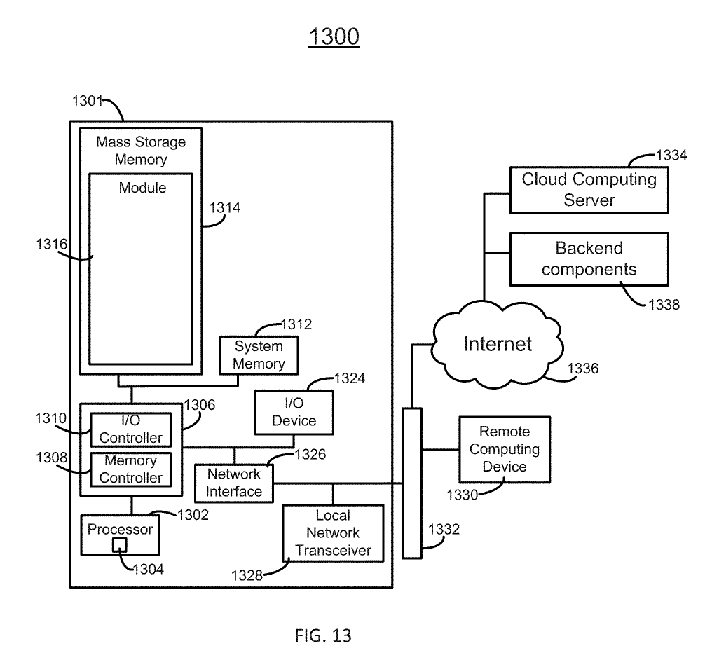

FIG. 13 may illustrate the physical elements that may be used by an account holder computing system 103 to access the merchant e-commerce computer system 104, the payment processing computer system 106, or other components of the system 100 as herein described. FIG. 13 may also describe a high-level block diagram of an example computing environment 1000 for the system 100 and methods 1000, 1100 for linking the primary account holder data 126A as a “card on file” for use in transactions between the electronic merchant payment application 154 and the merchant e-commerce computer system 104. The computing device 1301 may include a server (e.g., the payment processing system server 112, e-commerce server 130), a mobile computing device (e.g., account holder computer system 103, a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods described herein may be used to implement and execute the example systems of FIG. 1 and methods of FIG. 10 and FIG. 11. Although the example system 1300 is described below as including a plurality of peripherals, interfaces, chips, memories, etc., one or more of those elements may be omitted from other example processor systems used to implement and execute the example systems and methods. Also, other components may be added.

As shown in FIG. 13, the computing device 1301 includes a processor 1302 that is coupled to an interconnection bus. The processor 1302 includes a register set or register space 1304, which is depicted in FIG. 13 as being entirely on-chip, but which could alternatively be located entirely or partially off-chip and directly coupled to the processor 1302 via dedicated electrical connections and/or via the interconnection bus. The processor 1302 may be any suitable processor, processing unit or microprocessor. Although not shown in FIG. 13, the computing device 1301 may be a multi-processor device and, thus, may include one or more additional processors that are identical or similar to the processor 1302 and that are communicatively coupled to the interconnection bus.

The processor 1302 of FIG. 13 is coupled to a chipset 1306, which includes a memory controller 1308 and a peripheral input/output (I/O) controller 1310. As is well known, a chipset typically provides I/O and memory management functions as well as a plurality of general purpose and/or special purpose registers, timers, etc. that are accessible or used by one or more processors coupled to the chipset 1306. The memory controller 1308 performs functions that enable the processor 1302 (or processors if there are multiple processors) to access a system memory 1312 and a mass storage memory 1314, that may include either or both of an in-memory cache (e.g., a cache within the memory 1312) or an on-disk cache (e.g., a cache within the mass storage memory 1314).

The system memory 1312 may include any desired type of volatile and/or non-volatile memory such as, for example, static random access memory (SRAM), dynamic random access memory (DRAM), flash memory, read-only memory (ROM), etc. The mass storage memory 1314 may include any desired type of mass storage device. For example, the computing device 1301 may be used to implement a module 1316 (e.g., the various modules as herein described). The mass storage memory 1314 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 1301, the system 100, and methods 1000, 1100. Thus, a module, block, function, operation, procedure, routine, step, and method can be implemented in hardware, firmware, and/or software. In one embodiment, program modules and routines are stored in mass storage memory 1314, loaded into system memory 1312, and executed by a processor 1302 or can be provided from computer program products that are stored in tangible computer-readable storage mediums (e.g. RAM, hard disk, optical/magnetic media, etc.).

The peripheral I/O controller 1310 performs functions that enable the processor 1302 to communicate with a peripheral input/output (I/O) device 1324, a network interface 1326, a local network transceiver 1328, (via the network interface 1326) via a peripheral I/O bus. The I/O device 1324 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 1324 may be used with the module 1316, etc., to receive data from the transceiver 1328, send the data to the components of the system 100, and perform any operations related to the methods as described herein. The local network transceiver 1328 may include support for a Wi-Fi network, Bluetooth, Infrared, cellular, or other wireless data transmission protocols. In other embodiments, one element may simultaneously support each of the various wireless protocols employed by the computing device 1301. For example, a software-defined radio may be able to support multiple protocols via downloadable instructions. In operation, the computing device 1301 may be able to periodically poll for visible wireless network transmitters (both cellular and local network) on a periodic basis. Such polling may be possible even while normal wireless traffic is being supported on the computing device 1301. The network interface 1326 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 1308 and the I/O controller 1310 are depicted in FIG. 13 as separate functional blocks within the chipset 1306, the functions performed by these blocks may be integrated within a single integrated circuit or may be implemented using two or more separate integrated circuits. The computing environment 1300 may also implement the module 1316 on a remote computing device 1330. The remote computing device 1330 may communicate with the computing device 1301 over an Ethernet link 1332. In some embodiments, the module 1316 may be retrieved by the computing device 1301 from a cloud computing server 1334 via the Internet 1336. When using the cloud computing server 1334, the retrieved module 1316 may be programmatically linked with the computing device 1301. The module 1316 may be a collection of various software platforms including artificial intelligence software and document creation software or may also be a Java® applet executing within a Java® Virtual Machine (JVM) environment resident in the computing device 1301 or the remote computing device 1330. The module 1316 may also be a “plug-in” adapted to execute in a web-browser located on the computing devices 1301 and 1330. In some embodiments, the module 1316 may communicate with back end components 1338 via the Internet 1336.

The system 1300 may include but is not limited to any combination of a LAN, a MAN, a WAN, a mobile, a wired or wireless network, a private network, or a virtual private network. Moreover, while only one remote computing device 1330 is illustrated in FIG. 13 to simplify and clarify the description, it is understood that any number of client computers are supported and can be in communication within the system 1300.

The user devices, computers and servers described herein may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

There may be several technical problems that are addressed by the claimed system and method. First, traditionally sharing data between applications or services has been difficult. For the safety of users, the ability to share data between applications, especially on portable computing devices like smart phones, has been disabled. By having the data flow from an electronic merchant payment application 154 to the payment service module 118 or payment processing computer system 106 and then to the merchant e-commerce computer system 104, the problem of directly sharing data has been resolved. In addition, adding payment devices to merchant accounts has often been a tedious process which has met resistance as users are nervous about sharing payment details unnecessarily. Using the embodiments described herein, the payment data may only have to be entered in the electronic merchant payment application 154 and then the payment data may be securely shared to merchant accounts.

There may be several advantages to the described system. As mentioned previously, users may become annoyed if they have to repeatedly enter the same information over and over. Further, users become sensitive about transmitting the payment information to new merchants and sharing the sensitive payment information to too many merchants. By using the payment system 100 as a hub, the transmission of the payment information may be faster, more secure and less intrusive.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A system for securely adding a payment account to an electronic merchant payment application using a token-based electronic payment service, the system comprising:
an electronic merchant payment application stored in a memory of a mobile computing device, the mobile computing device including a processor that, upon executing instructions of the electronic merchant payment application:
sends a selection to add a payment account;
a payment processing system server including a processor and a memory storing a payment service module, the payment service module including instructions that, when executed by the processor, cause the payment processing system server to:
receive the selection to add the payment account to the electronic merchant payment application;
in response to receiving the selection, authorize the selection to add the payment account to the electronic merchant payment application; and
in response to authorizing the selection to add the payment account to the electronic merchant payment application, link primary account holder data to the electronic merchant payment application.

2. The system of claim 1, wherein the selection includes a login and password for the payment service module of the payment processing system server.

3. The system of claim 2, wherein the payment processing system server includes further instructions that, when executed by the processor, cause the payment processing system server to securely store the login and password at the payment service module.

4. The system of claim 3, wherein the instruction to link the primary account holder data to the electronic merchant payment application further includes an instruction to cause an interface of the electronic merchant payment application to display an indication that a payment device corresponding to the primary account holder data is available for a transaction between the electronic merchant payment application and a merchant e-commerce computer system.

5. The system of claim 4, wherein the payment processing system server includes further instructions that, when executed by the processor, cause the payment processing system server to tokenize the primary account holder data in response to receiving the transaction with the merchant e-commerce computer system using the electronic merchant payment application.

6. The system of claim 5, wherein the payment processing system server includes further instructions that, when executed by the processor, cause the payment processing system server to send a payment payload to the merchant e-commerce computer system in response to receiving the transaction between the electronic merchant payment application and the merchant e-commerce computer system.

7. The system of claim 6, wherein the instructions that, when executed by the processor, cause the payment processing system server to send the payment payload to the merchant e-commerce computer system in response to receiving the transaction between the electronic merchant payment application and the merchant e-commerce computer system include instructions that, when executed by the processor, cause the payment processing system server to encrypt the payment payload.

8. The system of claim 7, wherein the payment payload includes the tokenized primary account holder data and one or more of customer account data and a transaction amount.

9. The system of claim 8, wherein the tokenized primary account holder data includes a representation of a personal account number.

10. The system of claim 9, further comprising an electronic merchant payment application module stored in a memory of the merchant e-commerce computer system, the merchant e-commerce computer system including a processor that, upon executing instructions of the electronic merchant payment application module, issues a request to a tokenizing module of the payment processing computer system 106 to receive the payment payload.

11. A method for securely adding a payment account to an electronic merchant payment application using a token-based electronic payment service, the method comprising:
sending a selection to add a payment account to an electronic merchant payment application executing on a mobile computing device;
receiving the selection to add the payment account to the electronic merchant payment application at a payment processing system server remote from the mobile computing device;
in response to receiving the selection to add the payment account to the electronic merchant payment application, authorizing the selection to add the payment account to the electronic merchant payment application; and
in response to authorizing the selection to add the payment account to the electronic merchant payment application, linking primary account holder data to the electronic merchant payment application.

12. The method of claim 11, wherein the selection includes a login and password for a payment service module of the payment processing system server.

13. The method of claim 12, further comprising securely storing the login and password at the payment service module of the payment processing system server.

14. The method of claim 13, wherein linking the primary account holder data to the electronic merchant payment application further includes displaying, at an interface of the electronic merchant payment application, an indication that a payment device corresponding to the primary account holder data is available for a transaction between the electronic merchant payment application and a merchant e-commerce computer system.

15. The method of claim 14, further comprising tokenizing the primary account holder data in response to receiving the transaction with the merchant e-commerce computer system using the electronic merchant payment application.

16. The method of claim 15, further comprising sending a payment payload to the merchant e-commerce computer system in response to receiving the transaction between the electronic merchant payment application and the merchant e-commerce computer system.

17. The method of claim 16, wherein sending the payment payload to the merchant e-commerce computer system in response to receiving the transaction between the electronic merchant payment application and the merchant e-commerce computer system includes encrypting the payment payload.

18. The method of claim 17, wherein the payment payload includes the tokenized primary account holder data and one or more of customer account data and a transaction amount.

19. The method of claim 18, wherein the tokenized primary account holder data includes a representation of a personal account number.

20. The method of claim 19, further comprising issuing a request to a tokenizing module to receive the payment payload.
